(19) United States
(12) Patent Application Publication
(10) Pub. No.: US 2022/0093354 A1
(43) Pub. Date: Mar. 24, 2022

(54) Relay Holding Structure

(71) Applicant: Marelli Corporation, Saitama-shi, Saitama (JP)

(72) Inventors: Toshiyuki Motohashi, Saitama-shi, Saitama (JP); Hiroki Tomonaga, Saitama-shi, Saitama (JP); Naoto Kojima, Saitama-shi, Saitama (JP)

(21) Appl. No.: 17/310,381

(22) PCT Filed: Jan. 14, 2020
(86) PCT No.: PCT/JP2020/000896

§ 371 Date: Jul. 29, 2021

(30) Foreign Application Priority Data
Jan. 31, 2019 (JP) 2019-015350

(51) Int. Cl. H01H 50/04; H01M 10/42; H01M 50/249; H01M 50/244

(52) U.S. Cl. CPC H01H 50/047; H01M 10/42; H01M 2220/20; H01M 50/244; H01H 2050/049; H01M 50/249

(57) ABSTRACT

A relay holding structure has a relay, a first holding portion, a case, a second holding portion, a cover and an elastic member. The first holding portion and the second holding portion are formed of compressible resin foam. The first holding portion abuts against a first surface of the relay. The case supports the relay through the first holding portion. The second holding portion abuts against a second surface of the relay. The cover sandwiches the relay between it and the case through the first holding portion and the second holding portion. The elastic member engages the case and the cover so that the case and the cover press the relay. A clearance is provided between the case and the cover in an entire area viewing the case from the sandwiching direction of the relay.

### CROSS-REFERENCE TO RELATED APPLICATION

This application claims priority to and benefit of Japanese Patent Application No. 2019-15350 filed on Jan. 31, 2019, the entire contents of which are incorporated herein by reference.

### TECHNICAL FIELD

The present invention relates to a relay holding structure.

### BACKGROUND

For example, a battery device used in a vehicle or the like is provided with a relay. The relay emits operating noise when it operates on or off. When the relay is fixed to a case having a relatively high rigidity in the battery device, operating noise is transmitted to the case and can be increased. In order to prevent the operating noise from being transmitted to the case, it has been proposed to interpose an elastic member made of resin foam between the relay and the case (see Patent Literature (PTL) 1).

### CITATION LIST

### Patent Literature

PTL 1: JPH0982196 (A)

### SUMMARY

However, in the relay described in PTL 1, the fixing property of the relay by the elastic member in the case can be decreased due to decrease in elasticity of the elastic member caused by compression by deterioration with age or the like. When the fixing property of the relay by the elastic member is decreased, the relay may vibrate against the case when the vibration generated in the vehicle or the like on which the battery device or the like is mounted is transmitted to the case. As a result, stress is generated at the terminals of the relay, which may reduce the durability of the relay.

A relay holding structure according to a first aspect of the present invention to solve the above-described problem includes:

a relay;
a first holding portion that is formed of compressible resin foam and abuts against a first surface of the relay;
a case configured to support the relay through the first holding portion;
a second holding portion that is formed of compressible resin foam and abuts against a second surface on the opposite side of the first surface in the relay;
a cover configured to sandwich the relay between it and the case through the first holding portion and the second holding portion; and
an elastic member configured to engage the case and the cover so that the case and the cover press the relay, wherein,
in an entire area when the case is viewed from a sandwiching direction of the relay, a clearance is provided between the case and the cover in the sandwiching direction.

According to the present invention, a relay holding structure that maintains fixation of the relay regardless of deterioration of the resin foam while reducing the influence of transmission of operating noise to the case can be provided.

### BRIEF DESCRIPTION OF THE DRAWINGS

In the accompanying drawings:

FIG. 1 is a cross-sectional view schematically illustrating a relay holding structure according to an embodiment of the present invention;

FIG. 2 is an exploded view of a battery device to which the relay holding structure in FIG. 1 is applied;

FIG. 3 is an external perspective view of the lower surface of the cover in FIG. 2 viewed from an angle;

FIG. 4 is a cross-sectional view of the cover vied from A-A direction in FIG. 3;

FIG. 5 is an enlarged view focusing on a first holding portion, a relay and a second holding portion in FIG. 2;

FIG. 6 is a side view in a state in which the relay and the second holding portion are placed on the first holding portion in FIG. 2; and

FIG. 7 is an external perspective view in a state in which the relay and the second holding portion are placed on the first holding portion in FIG. 2.

### DETAILED DESCRIPTION

An embodiment of a relay holding structure to which the present invention is applied will be described below with reference to the drawings.

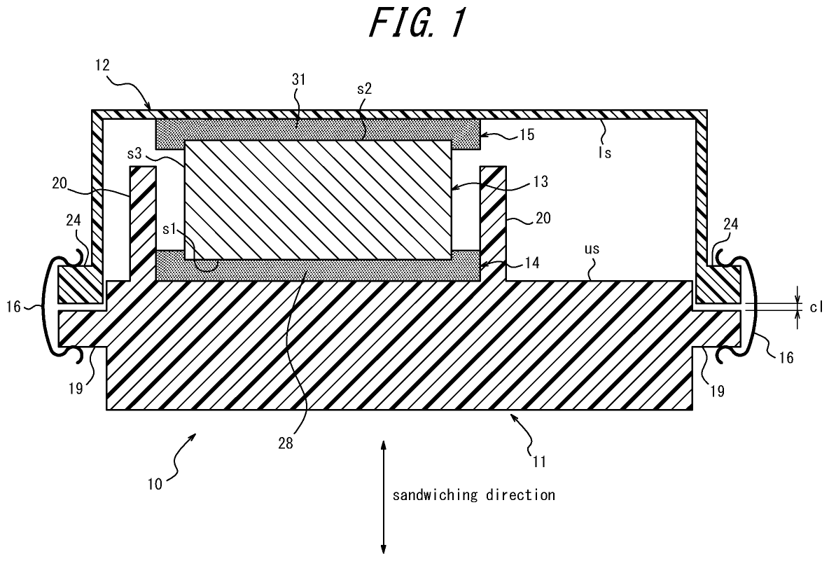

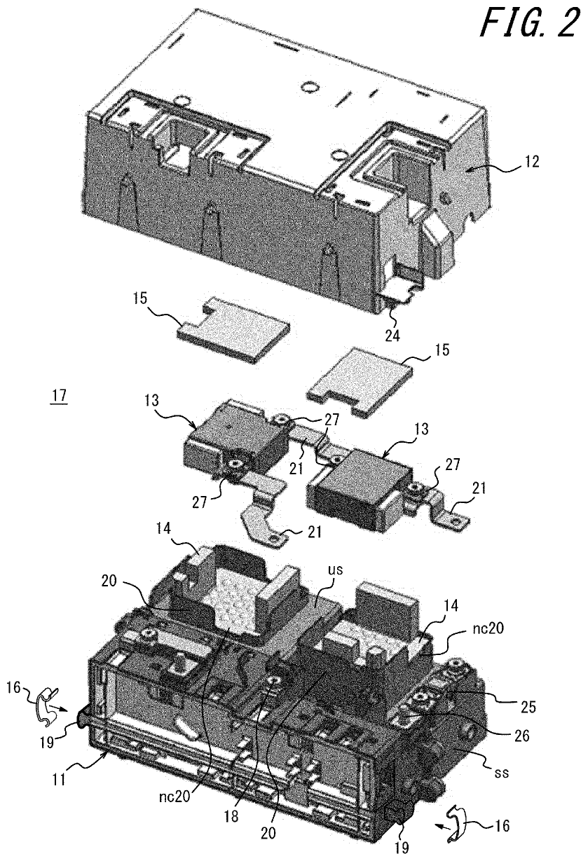

As illustrated in FIG. 1, a relay holding structure 10 according to an embodiment of the present invention includes a case 11, a cover 12, a relay 13, a first holding portion 14, a second holding portion 15 and an elastic member 16. As illustrated in FIG. 2, the relay holding structure 10 is applied to a battery device 17, for example.

On any one surface, the case 11 supports the relay 13 through the first holding portion 14 described later. The case 11 is formed of a relatively rigid material such as resin, and may have a substantially rectangular parallelepiped shape as a whole.

Assuming that the surface having the largest area on the outer surface of the case 11 is defined as a bottom surface and the surface opposite to the bottom surface is defined as an upper surface us, the case 11 may support the relay 13 on the upper surface us. The case 11 may contain an assembled battery connected to the relay 13. A terminal 18 connected to an electrode of the assembled battery may protrude from the upper surface us of the case 11.

The case 11 may have a section 19 of the case 11 configured to hook the elastic member 16 described later. The section 19 of the case 11 may be formed on the side surface of the upper surface us. It is preferable that the section 19 of the case 11 is formed at least two portions of the side surface, and it is more preferable that at least one section 19 is formed on any side surface and the other section 19 is formed on an opposite side surface of the side surface. The two sections 19 of the case 11 formed on the sides opposite to each other may be formed on the two side surfaces ss perpendicular to the long side direction of the case 11.

The case 11 may have a fixing frame 20 on the upper surface us. The fixing frame 20 may be substantially rectangular. The fixing frame 20 may support the first holding portion 14, which will be described later, in the direction perpendicular to the upper surface us in the frame. A notch nc 20 may be formed in a part of the fixing frame 20 to insert a drive line or a bus bar 21 that is connected to a coil terminal of the relay 13. As illustrated in FIG. 1, the end of the cover 12 side of the fixing frame 20 is located on the case 11 side of the surface s2 of the cover 12 side of the relay 13 in a state in which the first holding portion 14, which will be described later, and the relay 13 are placed in the fixing frame 20.

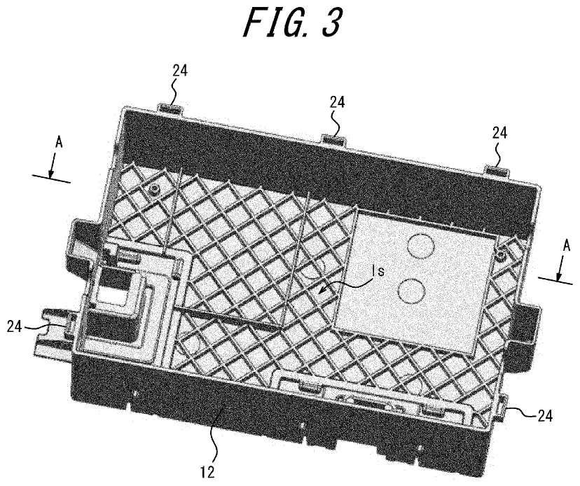

As illustrated in FIG. 2, the cover 12 covers the upper surface us of the case 11. The cover 12 sandwiches the relay 13 with the case 11 through the first holding portion 14 and the second holding portion 15 between it and the upper surface us that supports the relay 13 in the case 11. The cover 12 may sandwich the relay 13 between the upper surface us of the case 11 and the lower surface ls of the cover 12 facing the upper surface us (see FIG. 3).

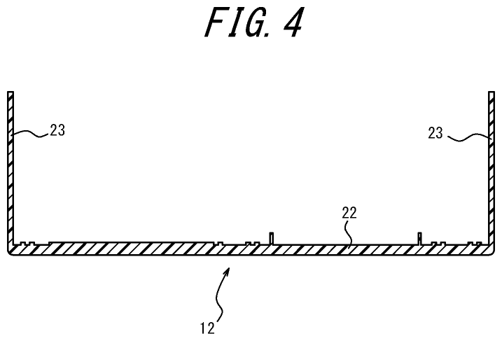

The cover 12 may be formed of a relatively rigid material such as resin and may have a substantially rectangular parallelepiped box shape with one surface opened. As illustrated in FIG. 2, the cover 12 may contain the case 11 so as to cover the upper surface us and four side surfaces of the case 11 from the upper surface us of the case 11. As illustrated in FIG. 4, the portion 22 of the cover 12 including the lower surface ls may have a higher rigidity than the portion 23 including the four sides by forming a thick structure or bead. As illustrated in FIGS. 1 and 3, the cover 12 may have sections 24 of the cover 12 to hook the elastic member 16 described later, on the surface facing the side surface on which the section 19 of the case 11 is formed.

In the relay holding structure 10, at least one relay 13 may be provided. As illustrated in FIG. 2, in this embodiment, the battery device 17 is provided with two relays 13. The two relays 13 may be connected in series using a bus bar 21. Furthermore, the two relays 13 may be connected in series with the assembled battery. Further, one of the relays 13 may be connected to the assembled battery through the bus bar 21 and the terminal 18. The other relay 13 may be connected to the output terminal 26 of the battery device 17 through the bus bar 21 and the fuse 25.

The relay 13 may switch between a cutoff state and an energized state on the basis of the control of the controller for controlling the battery device 17. The battery device 17 may stop power input/output by switching any or all of the relays 13 to a cutoff state. The battery device 17 may input/output the power by switching any or all of the relays 13 to an energized state.

As illustrated in FIG. 1, the relay 13 has at least a first surface s1 and a second surface s2. The first surface s1 is a surface on the opposite side of the second surface s2. The relay 13 is provided so that the first surface s1 faces the upper surface us that supports the relay 13 in the case 11.

The relay 13 has, for example, a substantially rectangular parallelepiped shape, and the two opposite surfaces having the largest area are the first surface s1 and the second surface s2. Further, the relay 13 having a substantially rectangular parallelepiped shape has four side surfaces connecting the first surface s1 and the second surface s2 as the third surface s3. The third surface s3 is vertical to the first surface s1 and the second surface s2. As illustrated in FIG. 2, among the third surfaces s3, a contact terminal 27 is provided to each of two surfaces facing each other.

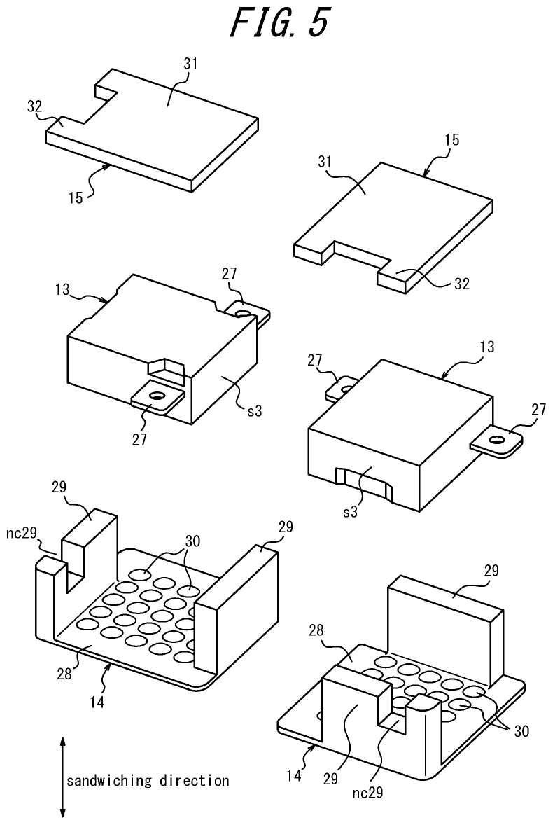

As illustrated in FIG. 1, the first holding portion 14 abuts against the first surface s1 of the relay 13. Therefore, the first holding portion 14 is sandwiched between the case 11 and the relay 13. As illustrated in FIG. 5, the first holding portion 14 may have a bottom portion 28 and wall portions 29.

As illustrated in FIG. 1, the bottom portion 28 may have a flat-plate shape, and may be disposed so that the plate surface is in parallel with the upper surface us and the first surface s1 of the case 11. As illustrated in FIG. 5, embossments 30 rising to the relay 13 side may be formed on the surface of the bottom portion 28 that abuts against the first surface s1. The embossment 30 may be, for example, spherical or cone-shaped. At least three embossments 30 may be formed on the bottom portion 28. At least three embossments 30 may deviate from the same straight line.

Each wall portion 29 has a surface perpendicular to the bottom portion 28 and may abut against the third surface s3 in the relay 13. Each wall portion 29 may be provided so as to abut against at least one of four side surfaces connecting the first surface s1 and the second surface s2, which is the third surface s3, in the substantially rectangular parallelepiped relay 13 as described above. In this embodiment, wall portions 29 are provided so as to face two side surfaces perpendicular to the two of four side surfaces where the contact terminal 27 of the relay 13 is provided. The hardness of each wall portion 29 may be smaller than that of the bottom portion 28 of the first holding portion 14 and of the bottom portion 31 of the second holding portion 15 described later. Therefore, each wall portion 29 is more flexible than the bottom portion 28 of the first holding portion 14 and the bottom portion 31 of the second holding portion 15, and is more deformable than the bottom portion 31 to the same stress.

Each wall portion 29 may have a positioning shape that positions the second holding portion 15 in the direction perpendicular to the plate surface of the bottom portion 28, in other words, in the sandwiching direction of the relay 13. The positioning shape is, for example, a notch nc 29. The notch nc 29 may be fitted to the protruding piece 32 of the second holding portion 15 to position the second holding portion 15, as will be described later. Further, the drive line of the relay 13 may be inserted into the notch nc 29 in a state in which the relay 13 is held by the first holding portion 14.

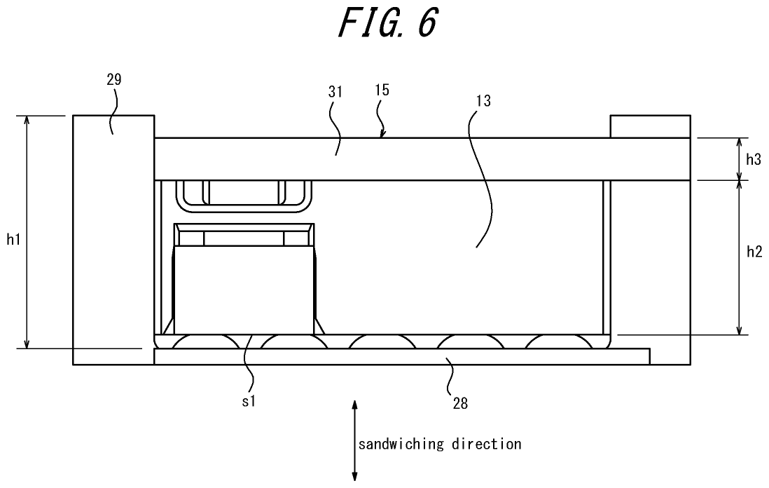

As illustrated in FIG. 6, the height h1 of the wall portion 29 from the side where the wall portion 29 of the bottom portion 28 stands may be longer than the height h2 in the direction perpendicular to the first surface s1 of the relay 13. Further, the height h1 of the wall portion 29 may be, in the state before the relay holding structure 10 is formed, longer than a total length of the height h2 in the direction perpendicular to the first surface s1 of the relay 13 and the thickness h3 in the direction perpendicular to the plate surface of the bottom portion 31 of the second holding portion 15 described later.

The first holding portion 14 is formed of compressible resin foam. The resin foam may have elasticity that allows for restoration to the original shape when released from stress. It is to be noted that, restoration to the original shape is not limited to complete restoration to the shape before being stressed, and may be restoration in the direction opposite the compressed direction. Therefore, this resin foam generates elastic reaction force to the stress when the stress is applied.

In this embodiment, chip urethane, which is a soft resin foam, is used as the resin foam used for the first holding portion 14. The chip urethane is made by crushing the end material of a cushion made of flexible polyurethane foam, putting it in a mold together with a binder, and pressing it. In a configuration in which the first holding portion 14 is formed of urethane chips, the hardness of the wall portion 29 can be reduced compared with the bottom portion 28 by pressing the wall portion 29 at a lower compressibility than that of the bottom portion 28.

When chip urethane is used for the first holding portion 14, the bottom portion 28 and the wall portion 29 may be integrally formed by a mold. Further, when chip urethane is used for the first holding portion 14, the bottom portion 28 and the wall portion 29 in a flat plate shape are molded separately, then the wall portion 29 may be bonded to the bottom portion 28 with adhesive, or the like.

As illustrated in FIG. 1, the second holding portion 15 abuts against the second surface s2 of the relay 13. Therefore, the second holding portion 15 is sandwiched between the cover 12 and the relay 13. As illustrated in FIG. 5, in this embodiment, the second holding portion 15 has a bottom portion 31. As with the first holding portion 14, the second holding portion 15 may have a wall portion not illustrated.

The bottom portion 31 may be a flat-plate shape, and as illustrated in FIG. 1, the plate surface may be disposed so that it is in parallel to the lower surface is and the second surface s2 of the cover 12. As with the first holding portion 14, the surface of the bottom 31 that abuts against the second surface s2 may be embossed.

As illustrated in FIG. 5, the bottom portion 31 may have the protruding piece 32 at least one end of the plate surface. The width of the protruding piece 32 may be equal to that of the notch nc 29 of the first holding portion 14. When the protruding piece 32 is fitted into the notch nc 29 with the bottom portion 28 of the first holding portion 14 and the bottom portion 31 and the second holding portion 15 are parallel to each other, the second holding portion 15 is positioned in the direction perpendicular to the plate surface of the wall portion 29 and the bottom portion 28 of the first holding portion 14.

The second holding portion 15 is formed of resin foam. The configuration of the resin foam is the same as that of the first holding portion 14. As described above, the hardness of the bottom portion 31 of the second holding portion 15 may be higher than that of the wall portion 29 of the first holding portion 14. Therefore, the wall portion 29 of the first holding portion 14 is more flexible than the second holding portion 15 and is easily deformed under the same stress.

As illustrated in FIG. 1, the elastic member 16 engages the case 11 and the cover 12 so that the case 11 and the cover 12 press the relay 13. The elastic member 16 may be a clip, for example. The relay 13 is pressed through the case 11, the first holding portion 14, the second holding portion 15 and the cover 12 by hooking the elastic member 16, which is a clip, on the section 19 of the case 11 and the section 24 of the cover 12.

In the battery device 17, the relay holding structure 10 is manufactured through the steps described below. As illustrated in FIG. 2, the case 11 containing the assembled battery is disposed so that the bottom surface faces vertically downward. The first holding portion 14 is placed on the case 11 so that the wall portion 29 faces vertically upward and the upper surface us and the bottom portion 28 contact each other in the fixing frame 20 of the case 11.

Next, the relay 13 is placed on the first holding portion 14. It is to be noted that, in a state in which the relay 13 is placed, the first surface s1 faces the plate surface of the bottom portion 28 of the first holding portion 14. Further, in a state in which the relay 13 is placed, the contact terminal 27 protrudes from the notch nc 20 of the fixing frame 20.

The contact terminals 27 of the two relays 13 are connected to each other through the bus bar 21. The contact terminal 27 of one relay 13 is connected to the terminal 18 that is coupled to the electrode of the assembled battery through the bus bar 21. The contact terminal 27 of the other relay 13 is connected to the fuse 25 through the bus bar 21.

The second holding portion 15 is placed on the second surface s2 of the relay 13 so that the plate surface of the bottom portion 31 faces the second surface s2. The second holding portion 15 is placed so that the protruding piece 32 is fitted into the notch nc 29 of the first holding portion 14.

The cover 12 covers the case 11 so that the section 24 of the cover 12 faces the section 19 of the case 11. The upper surface us of the case 11 is pressed against the lower surface is side of the cover 12 to compress the first holding portion 14 and the second holding portion 15. With the first holding portion 14 and the second holding portion 15 compressed, the elastic member 16 is hooked on the section 19 of the case 11 and the section 24 of the cover 12.

As illustrated in FIG. 1, in the relay holding structure 10 in which the relay 13 is sandwiched between the case 11 and the cover 12, a clearance c1 is provided between the case 11 and the cover 12 in the sandwiching direction, in an entire area when the case 11 is viewed from the sandwiching direction of the relay 13. The entire area includes not only the engagement portion between the case 11 and the cover 12, but also the internal space created by the case 11 and the cover 12. For example, as illustrated in FIG. 1, even if the fixing frame 20 is protruded from the case 11 toward the cover 12 side, the clearance c1 is provided between the cover 11 and the fixing frame 20 in the sandwiching direction.

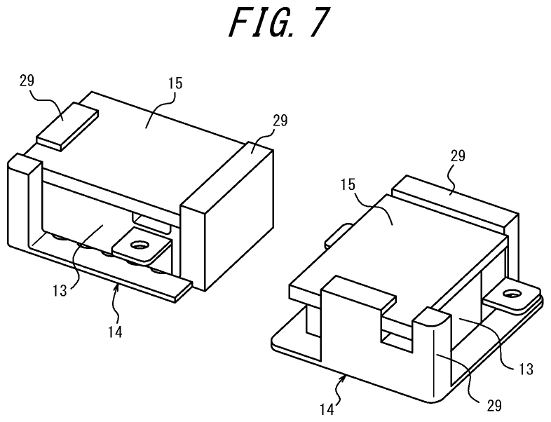

As described above using FIG. 6, the height h1 of the bottom portion 28 on the side on which the wall portion 29 of the bottom portion 28 stands may be, in the state before the relay holding structure 10 is manufactured, longer than a total length of the height h2 in the direction perpendicular to the first surface s1 of the relay 13 and the thickness h3 in the direction perpendicular to the plate surface of the bottom portion 31 of the second holding portion 15. Thus, as illustrated in FIG. 7, in a state in which the relay 13 and the second holding portion 15 are placed on the first holding portion 14, the wall portion 29 of the first holding portion 14 protrudes from the plate surface of the bottom portion 31 of the second holding portion 15.

As illustrated in FIG. 1, when the cover 12 is pressed in the sandwiching direction of the relay 13 while covering the case 11, the first holding portion 14 and the second holding portion 15 are compressed in the sandwiching direction. When the first holding portion 14 and the second holding portion 15 are compressed in the sandwiching direction, the height position of the wall portion 29 of the first holding portion 14 and that of the bottom portion 31 of the second holding portion 15 are substantially the same with reference to the bottom portion 28 of the first holding portion 14. It is to be noted that, in the relay holding structure 10, when pressing of the relay 13 by the elastic member 16 is released, the shape of at least a part of the first holding portion 14 and the second holding portion 15 restores, and in the sandwiching direction, the wall portion 29 of the first holding portion 14 protrudes from the plate surface of the bottom portion 31 of the second holding portion 15.

In the relay holding structure 10 according to the above-described embodiment, the relay 13 is sandwiched between the case 11 and the cover 12 through the first holding portion 14 and the second holding portion 15 formed of compressible resin foam. With the configuration described above, the relay holding structure 10 can reduce the influence of transmitting the operating noise generated at the relay 13 to the case 11. Further, in the relay holding structure 10 according to this embodiment, the elastic member 16 engages the case 11 and the cover 12 so that the relay 13 is pressed, and a clearance c1 is provided between the case 11 and the cover 12 in the sandwiching direction, in the entire area viewing the case 11 from the sandwiching direction of the relay 13. With such a configuration, in the relay holding structure 10, even if the elasticity of at least one of the first holding portion 14 and the second holding portion 15 is decreased due to deterioration over time, pressing of the relay 13 by the elastic member 16 through the first holding portion 14 and the second holding portion 15 can be maintained until the clearance c1 disappears in anywhere. Therefore, since the relay holding structure 10 suppresses a decline in the fixation of the relay 13, concentration of stress on the contact terminal 27 of the relay 13 is decreased, and durability of the relay 13 and durability of the bus bar 21c connected are improved.

Further, in the relay holding structure 10 according to this embodiment, the embossments 30 rising to the relay 13 side are formed on the surface that abuts against the first surface s1 of the first holding portion 14. With the above-described configuration, in the relay holding structure 10, a space is created between the bottom portion 28 and the first surface s1 of the relay 13. In this space, the operating noise is repeatedly absorbed and reflected by the bottom portion 28 and the embossments 30, and as a result the operating noise of the relay is damped.

Further, in the relay holding structure 10 according to this embodiment, the first holding portion 14 has the wall portion 29 that abuts against the third surface s3 of the relay 13. With such a configuration, the relay holding structure 10 can reduce vibration of the relay 13 in the direction orthogonal to and parallel to the third surface s3. In the relay holding structure 10 having the above-described configuration, the cover 12 can press the bottom portion 31 of the second holding portion 15 and the wall portion 29 of the first holding portion 14. Since the wall portion 29 of the first holding portion 14 does not contribute to pressing of the relay 13 in the sandwiching direction, a force to press the relay 13 in the sandwiching direction is reduced. On the other hand, in the relay holding structure 10, the hardness of the wall portion 29 of the first holding portion 14 is lower than that of the bottom portion 31 of the second holding portion 15. With such a configuration, in the relay holding structure 10, the reaction force to the compression of the wall portion 29 not contributing to pressing of the relay 13 in the sandwiching direction can be reduced compared with the reaction force to the compression of the bottom portion 31 of the second holding portion 15 directly contributing to pressing of the relay 13 in the sandwiching direction. Therefore, although the relay holding structure 10 has the wall portion 29, it can firmly hold the relay 13 in the sandwiching direction while suppressing a decrease in the force to press the relay 13 in the sandwiching direction.

Further, in the relay holding structure 10 according to this embodiment, the wall portion 29 of the first holding portion 14 has a shape with which the second holding portion 15 is positioned in the direction perpendicular to the sandwiching direction. With such a configuration, it is easy that the relay holding structure 10 can position during manufacture, and manufacture can be facilitated. Therefore, the relay holding structure 10 can improve productivity.

Further, in the relay holding structure 10 according to this embodiment, the notch nc 29 fitted to the second holding portion 15 is formed in the wall portion 29, and the drive line of the relay 13 is inserted to pass through the notch nc 29. With such a configuration, in the relay holding structure 10, the notch nc 29 used for positioning the second holding portion 15 can be used also as a hole through which the drive line is passed. Thus, compared with a configuration in which an insertion hole is formed separately from the notch nc 29, an assembly process and man hours can be reduced.

Further, in the relay holding structure 10 according to this embodiment, when press of the relay 13 by the elastic member 16 through the case 11 and the cover 12 is released, in the sandwiching direction, a part of the wall portion 29 of the first holding portion 14 protrudes from the plate surface of the bottom portion 31 of the second holding portion 15. In this configuration, even before the relay holding structure 10 is manufactured, when the relay 13 and the second holding portion 15 are placed on the first holding portion 14 in the sandwiching direction, the wall portion 29 of the first holding portion 14 can be protruded from the plate surface of the bottom portion 31 of the second holding portion 15. Therefore, in the relay holding structure 10, whether the second holding portion 15 is positioned to the first holding portion 14 is easily viewed during manufacture, and as a result reliability can be improved.

Further, in the relay holding structure 10 according to this embodiment, the second holding portion 15 is formed into a plate shape. The second holding portion 15 formed of urethane chips can be manufactured by simply punching a plate-shaped general-purpose product if it is plate-shaped, and is also easy to manufacture. Therefore, the relay holding structure 10 can reduce the manufacturing cost and improve the productivity.

Further, in the relay holding structure 10 according to this embodiment, at least three embossments 30 are formed on the bottom portion 28 of the first holding portion 14. With such a configuration, the relay holding structure 10 defines a face of the bottom portion 28 that abuts against the first surface s1 of the relay 13, and a force per embossment 30 to press the relay 13 can be reduced. Therefore, since it is not necessary for the case 11, the cover 12 and the elastic member 16 to have an excessive strength, the battery device 17 can be easily miniaturized and light-weighted, and as a result ease of mounting on vehicles can be improved.

Further, in the relay holding structure 10 according to this embodiment, the embossment 30 is spherical or conical. Such a configuration allows the relay holding structure 10 to have an expanded contact area with the relay 13 due to compression by the embossments 30, as the pressing of the first holding portion 14 increases. Therefore, in the relay holding structure 10, the area to be contact with the relay 13 increases as the amplitude of vibration increases, which increases the reaction force of the first holding portion 14. As a result, the relay 13 can be stably held in the sandwiching direction.

Further, in the relay holding structure 10 according to this embodiment, the first holding portion 14 and the second holding portion 15 are formed of chip urethane. With such a configuration, in the relay holding structure 10, the reaction force of the first holding portion 14 and the second holding portion 15 increases as the amplitude increases. However, when the amplitude exceeds a certain level, the reaction force can be converged.

Further, in the relay holding structure 10 according to this embodiment, the lower surface is of the cover 12 is formed to have thickness or bead. With such a configuration, the relay holding structure 10 can reduce the influence of transmission of sound and vibration from the relay 13.

It will be obvious to those skilled in the art that the present invention can be realized in certain forms other than those described above without departing from its spirit or its essential characteristics. Therefore the foregoing description is illustrative and not limited thereto. The scope of the invention is defined by the appended claims rather than by the foregoing description. Some of all changes which come within the range of equivalency of the claims are therefore intended to be embraced therein.

For example, in this embodiment, when viewed from the sandwiching direction of the relay 13, between the case 11 and the cover 12, a gap is formed in an area other than the area in which the first holding portion 14, the relay 13 and the second holding portion 15 are disposed. However, configuration is not limited to this. A member softer than the first holding portion 14 and the second holding portion 15, such as a sponge-like seal member may be provided in the gap.

### REFERENCE SIGNS LIST

10 Relay holding structure
11 Case
12 Cover
13 Relay
14 First holding portion
15 Second holding portion
16 Elastic member
17 Battery device
18 Terminal
19 Section of case
20 Fixing frame
21 Bus bar
22 Portion including lower surface of cover
23 Portion including side surface of cover
24 Section of cover
25 Fuse
26 Output terminal
27 Contact terminal
28 Bottom portion of first holding portion
29 Wall portion of first holding portion
30 Embossment
31 Bottom portion of second holding portion
32 Protruding piece
c1 Clearance
nc 20 Notch of fixing frame
nc 29 Notch of wall portion
s1 First surface
s2 Second surface
s3 Third surface
ss Side surface of case
us Upper surface of case
ls Lower surface of cover

1. A relay holding structure, comprising:
a relay;
a first holding portion that is formed of compressible resin foam and abuts against a first surface of the relay;
a case configured to support the relay through the first holding portion;
a second holding portion that is formed of compressible resin foam and abuts against a second surface on the opposite side of the first surface of the relay;
a cover configured to sandwich the relay between it and the case through the first holding portion and the second holding portion; and
an elastic member configured to engage the case and the cover so that the case and the cover press the relay, wherein
in an entire area when the case is viewed from a sandwiching direction of the relay, a clearance is provided between the case and the cover in the sandwiching direction.

2. The relay holding structure according to claim 1, wherein an embossment rising to the relay side is formed on at least one of a surface that abuts against the first surface of the first holding portion and a surface that abuts against the second surface of the second holding portion.

3. The relay holding structure according to claim 1, wherein
at least one of the first holding portion and the second holding portion has a wall portion that abuts against a third surface perpendicular to the first surface and the second surface of the relay; and
the wall portion has a hardness lower than that of a bottom portion facing the first surface and the second surface included in the first holding portion and the second holding portion, respectively.

4. The relay holding structure according to claim 3, wherein the wall portion included in at least one of the first holding portion and the second holding portion has a shape that positions the other in a direction perpendicular to the sandwiching direction.

5. The relay holding structure according to claim 4, wherein a notch to be fitted to the other is formed in the wall portion, and a drive line of the relay is inserted to pass through the notch.

6. The relay holding structure according to claim 4, wherein when pressing of the relay by the elastic member through the case and the cover is released, a part of the wall portion protrudes from a bottom portion of the other in the sandwiching direction.
